(19) United States
(12) Patent Application Publication
(10) Pub. No.: US 2010/0142330 A1
(43) Pub. Date: Jun. 10, 2010

(54) ATTACHABLE DEVICE FOR PILL CONTAINER

(75) Inventor: Patrick Reygaert, Edegem (BE)

Correspondence Address: REINHART BOERNER VAN DEUREN P.C., 2215 PERRYGREEN WAY, ROCKFORD, IL, 61107, US

(73) Assignee: GENERICS (UK) LIMITED, Hertfordshire (GB)

(21) Appl. No.: 12/514,026

(22) PCT Filed: Oct. 30, 2007
(86) PCT No.: PCT/EP2007/061700

§ 371 Date: Jan. 8, 2010

(30) Foreign Application Priority Data
Nov. 9, 2006 (EP) 06123736.8

(51) Int. Cl. G04B 47/00

(52) U.S. Cl. 368/10

(57) ABSTRACT

The present invention is related to a device attachable to a pill container to alert a person when a pill or a medication has to be taken, the device comprising a case having a top case (1), a bottom case (2) suitable to engage with the pill container (3), said case comprising a clock and timer electronic circuit (4) to provide current time in hours and minutes and to provide an alarm signal, power source means (5), alarm means responsive to said alarm signal, sensing means (7) for detecting an access to the pill container (3), memory means (8) to store alarm time and to record access to the pill container, a LCD unit (10) to display current time, alarm time and information relating to the compliance of pills, a LCD lens (11), selector means (12) comprising means (13) to set the time clock, means (14) to set the alarm, means (15) to adjust clock time or adjust clock alarm time.

### FIELD OF THE INVENTION

The present invention relates to a device, attachable to a pill container, to alert a person when a pill or a medication has to be taken and enabling to check his or her compliance with the pill or medication prescription regimen.

### BACKGROUND OF THE INVENTION

Most of the pills, e.g. vitamins pills, nutritional supplements, minerals, and especially medication pills have to be taken at prescribed times. However, often one forgets to take the pill when the appropriate time comes, forgets also when his/her last intake was, and usually does not take record of his/her compliance or non-compliance with the pills or medications prescription regimens.

Devices using electronic systems for reminding a person to take medication are known in the prior art.

Particularly, the document WO-A-0039763 describes a device attachable to a receptacle comprising a timer programmed for timing a predetermined interval for taking a medication. Thus, said device provides acoustic and visual alarm signals one to four times a day. The removal of the device, sensed by the timing circuit, resets the alarm.

Furthermore, the document WO-A-03104905 describes a device attachable to a receptacle for timing predetermined interval, according to a timing schedule, comprising an electronic circuit to provide alarm signals one to four times a day and sensing means to detect the access to the receptacle, i.e. removal of the device. The device has the feature of maintaining the time so that, if the device is opened before the scheduled alarm, it will skip the scheduled alarm signal.

However, these devices have main drawbacks. The time alarms are provided at fixed intervals of times and not at specific real time. Thus, these devices are not easily adjustable, especially to take into account sleeping period of the patient. Furthermore, as there is no registration of container opening, the patient cannot check whether or not he/she has taken the pill, when his/her last intake was, and cannot check the compliance with the prescription regimen unless opening the pill container and counting the number of remaining pills.

### AIMS OF THE INVENTION

The object of the present invention is to provide a device attachable to a pill container for alerting a person when a pill or a medication has to be taken which overcomes the drawbacks from the prior art.

The word “pills” has to be understood as referring to any suitable form for oral absorption of medication, vitamins, minerals, nutritional supplements, such as tablets, capsules or caplets.

Particularly, the aim of the present invention is to provide a device attachable to a pill container capable of scheduling pill administration, alerting the user of a scheduled administration time and monitoring the compliance of the administration schedule.

It is also an object of the present invention to provide a method and a program to remind a person when a pill has to be taken.

Furthermore, it is also an object of the present invention to provide a method and a program to retrieve information concerning the data relating to compliance of pills.

### SUMMARY OF THE INVENTION

The present invention is related to a device attachable by appropriate means to a pill container, comprising a case having a top case, a bottom case suitable for engaging with the pill container, said case comprising a clock and timer electronic circuit able to provide current time in hours and minutes and able to provide an alarm signal, power source means, alarm means responsive to said alarm signal, sensing means for detecting an access to the pill container, memory means to store alarm time and to record access to the pill container, a LCD display to display suitable information relating to the compliance of pills, a LCD unit to display current time, alarm time, a LCD lens, selector means comprising means to set the time clock, means to set the alarm, means to adjust clock time or adjust clock alarm time

Preferably, the device furthermore comprises compliance verification means to provide information on pill container access to be displayed.

Advantageously, the compliance verification means are able to give the time elapse since last registration of access to pill container and are able to execute statistical data analysis to provide e.g. average access to pill container per day or per week.

Preferably, the compliance verification means comprises means to check information provided by said compliance verification means.

Preferably, said compliance verification means comprise microprocessor to execute operational control of electronic function and data analysis.

Furthermore the device of the present invention can comprise one or more, alone or in combination, following features:
the selector means are accessible from the top surface of the top case.
the clock and timer electronic circuit provides an alarm signal at specific real time or with variable intervals.
the power source means is a battery.
the alarm means provide an acoustic signal and/or a visual signal and/or a sensitive signal.
the alarm means can comprise a speaker and/or flashing light to illuminate the LCD unit and/or a light pipe.
the light pipe is a light-emitting diode (LED) light pipe.
the selector means comprise pressure sensitive switches connected to the clock and timer electronic circuit.
the clock and timer electronic circuit comprises an upper surface and a lower surface, and wherein the LCD unit and selector means are mounted on said upper surface and wherein the speaker, the power source means and the sensing means are in electrical communication with said lower surface.
the memory means is a Random access memory (RAM).
the sensing means comprise a switch activator which cooperates with mechanical switch to switch off the alarm means and to register the pill container accessing in the memory means.
the device can further comprise an inner frame to engage with the pill container, said case been pivotally connected to said inner frame by a hinge.
the switch activator is an inner sleeve which is deformed when the device closes the pill container to urge the mechanical switch upward to actuate the clock and timer electronic circuit.
the sensing means can further comprise a rib which is part of the inner frame and which cooperates with the switch activator to urge the mechanical switch upward to actuate the clock and timer electronic circuit.
the mechanical switch is preferably a spring.
the switch activator has the shape of an arm or a dome.
the switch activator is an elastomeric dome.
the pill container is a bottle, a box, a card board box, or a blister.
the case has a cylindrical shape if the pill container is a bottle or a rectangular shape if the pill container is a box, a card or a blister.
the device is able to be adapted to any side of a standard pill packing box.
the dimensions of the device are such that the device is attachable through attaching means to a conventional container such as a bottle, a box, a card box, a card board box or a blister.
the device is a cap which may be screwably attached to the pill container when said pill container is a bottle.
the case is made of mouldable plastic.

The present invention also discloses a method and a computer program to remind a person when a pill has to be taken using the device according to the present invention.

The present invention also discloses a method for monitoring a person compliance with pill intake.

### BRIEF DESCRIPTION OF THE DRAWINGS

FIG. 1 is an exploded view of a first embodiment of the invention.

FIG. 2 is a longitudinal section of the particular embodiment of FIG. 1 and shows a particular embodiment of the sensing means.

FIG. 3 is a longitudinal section of the particular embodiment of FIG. 1 and shows the sensing means when the device of the present invention closes the pill container.

FIG. 4 is an exploded view of a second embodiment of the invention.

FIG. 5 is a perspective view of the second embodiment of the invention, the device closing the pill container.

FIG. 6 is a perspective view of the second embodiment of the invention, the device being in the open position.

FIG. 7 shows a longitudinal section of the particular embodiment of FIG. 4 and shows a first embodiment of the sensing means.

FIG. 8 is a longitudinal section of the particular embodiment of FIG. 4 and shows the particular embodiment of the sensing means of FIG. 7 when the device of the present invention closes the pill container.

FIG. 9 shows a longitudinal section of the particular embodiment of FIG. 4 and shows a second embodiment of the sensing means.

FIG. 10 is a longitudinal section of the particular embodiment of FIG. 4 and shows the particular embodiment of the sensing means of FIG. 9 when the device of the present invention closes the pill container.

FIG. 11 shows a longitudinal section of the particular embodiment of FIG. 4 and shows a third embodiment of the sensing means.

FIG. 12 is a longitudinal section of the particular embodiment of FIG. 4 and shows the particular embodiment of the sensing means of FIG. 11 when the device of the present invention closes the pill container.

FIG. 13 is a plan view of the operating face of the device of the present invention.

### DETAILED DISCLOSURE OF THE INVENTION

In relation to the appended drawings the present invention is described in detail in the sequel. It is apparent however that a person skilled in the art can imagine several other equivalent embodiments or other ways of executing the present invention, the spirit and scope of the present invention being limited only by the terms of the appended claims.

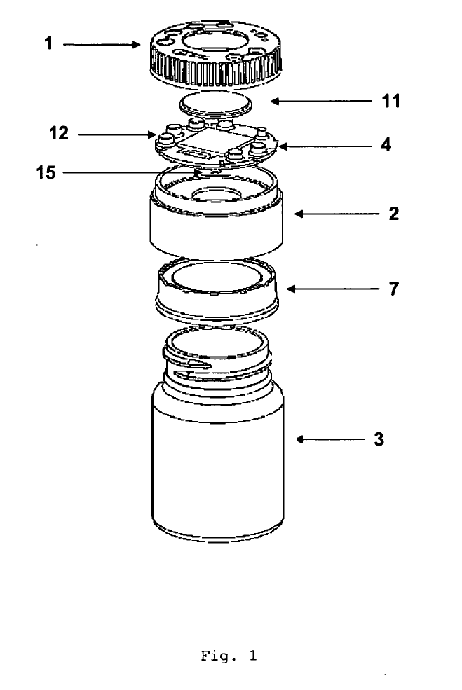

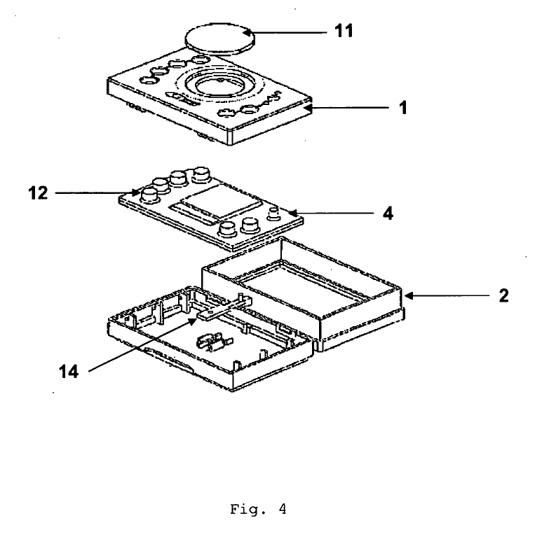

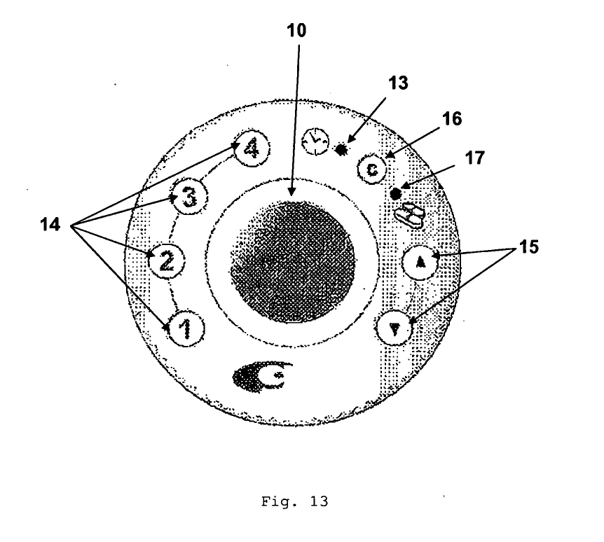

Referring to FIG. 1 and FIG. 4, the device of the present invention comprises a case having a top case 1 and bottom case 2, said bottom case 2 being suitable for engaging the pill container 3. The device comprises a clock and timer electronic circuit 4 to provide current time in hours and minutes and to provide an alarm signal, power source means 5, alarm means 6 responsive to said alarm signal, sensing means 7 for detecting an access to the pill container 3, memory means 8 to store alarm time and to record access to the pill container 3, compliance verification means 9 to provide information on pill container 3 access to be displayed on LCD unit 10 which displays current time, alarm time and information provided by compliance verification means 9 and selector means, a LCD lens 11, and selector means 12. Said selector means 12 comprises means 13 to set the time clock, means 14 to set the alarm, means 15 to adjust clock time (FIG. 13) or adjust clock alarm time, means 16 and 17 to check information provided by compliance verification means 9.

The device according to the present invention has an easy to read display and allows an easy setting of one or more alarms using selector means 12, an easy control of the alarm time setting and an easy control of the patient or user compliance.

The device of the present invention is a scheduling device attachable to a pill container 3, capable of notifying a person when to take his/her medication. The device is also capable of tracking whether or not the person has taken his/her medicine after the notification and capable of giving statistical information about his/her compliance.

The pill container 3 and the device of the present invention may be provided to the patient, or user, already assembled by the pill container manufacturer. Preferably, the device is provided alone and it is the pharmacist or the user who attaches the device to any pill container 3 which can be empty or already filled with pills.

The clock and timer electronic circuit 4 is a conventional printed board circuit which is suitable for providing current time and capable of providing an alarm signal at the expiration of one or more time intervals, preferably at a specific real time. Preferably, the electronic circuit 4 is an assembly of such a printed board circuit, a Liquid Crystal Display (LCD) unit 10 and selector means 12. Preferably, the LCD unit 10 and the selector means 12 are mounted on the upper surface of the electronic circuit 4 as shown in FIGS. 1 and 4.

The LCD unit 10 displays the current time, in hours and minutes, in digital form, on a twelve, or preferably, on a twenty four-hour basis, the number of alarms currently set and the particular time for which the current alarms are set, and all information provided by the selector means 12 and the compliance verification means 9. The LCD unit 10 may also display current battery power level and a “broken battery” symbol if the battery is depleted.

The selector means 12 are preferably pressure sensitive switches connected to the electronic circuit 4 and been accessible from the top surface of the top case 1. The selector means 12 is used for directing information to the LCD unit 10 and for entering information into the memory means 8. Referring to FIG. 13, the selector means are used to program the clock and timer electronic circuit 4 to the current correct time by using means 13 and means 15, to set alarm time by using means 14 and means 15, to check compliance by using means 16, or means 17 and means 15.

The electronic circuit 4 further comprises memory means 8 (not shown) and compliance verification means 9 (not shown). The memory means 8 is preferably a random access memory (RAM) to store alarm time and to store information provided by the compliance means 9. The compliance verification means 9 is preferably a microprocessor to execute operational control of electronic function and capable of executing statistical data analysis, such as, but not limited to, providing the average number of access to the pill container 3 per day and per week, and providing the time elapse since last registration of access to the pill container 3.

The microprocessor compares the current time, as maintained by the clock circuit, with any alarm settings stored in the memory means 8. When the preset time for the alarm has been reached, the alarm means 6 actuates the alarm. In case of time interval alarms, the next alarm time is automatically calculated and placed in memory means 8.

Preferably the microprocessor is controlled by software instructions, preferably part of the microprocessor, but alternatively, this instructions could be stored in a memory integrated to the microprocessor or external, e.g. in a EPROM or flash ROM device. Alternatively, these instructions could be converted into equivalent electronic circuitry for carrying out the same functions.

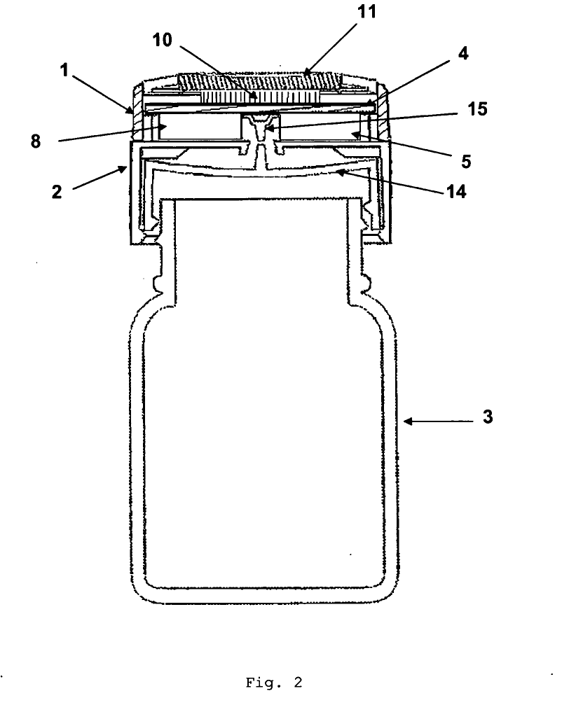

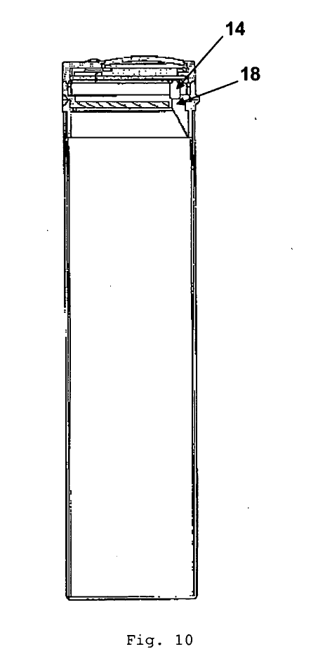

On the lower surface of the electronic circuit 4, the power source means 5, alarm means 6, and the sensing means 7 are in electrical communication with said electronic circuit 4 as shown in FIGS. 2 and 10.

The power source means 5 is any suitable conventional battery, which may be preferably a rechargeable battery.

The alarm means 6 comprises any conventional device providing an acoustic alarm signal, preferably, a speaker 13 responding to alarm signal provided by the electronic circuit 4 and emitting a conventional “beep” signal or any suitable acoustic signal. As the alarm signal may also be a visual signal, the speaker 13 can operate in combination with a flashing light which illuminates the LCD unit 10.

The attachment of the device to the container is performed through attaching means which are cooperating with the sensing means able to detect the access to the pill container.

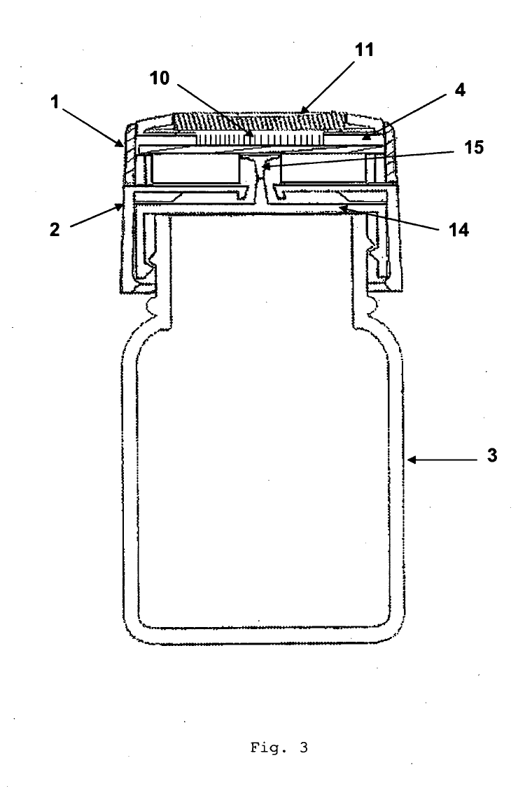

The sensing means 7 is any suitable device for detecting an access to the pill container, preferably said sensing means 7 comprises switch activator 14 which cooperates with mechanical switch 15 to switch off the alarm means and to register in the memory means 8 the access to the pill container 3. Referring to FIGS. 1 to 3, the switch activator 14 may comprise an inner sleeve having concave shape in the normal position (relaxed position), and a plan position (flexed position) when the bottom case 2 engages the pill container 3. The top edge of said pill container 3 forces the inner sleeve to move the mechanical switch 15 upward to actuate the electronic circuit 4. Preferably, said inner sleeve wears off the top edge of the bottle and seals against the bottle edge.

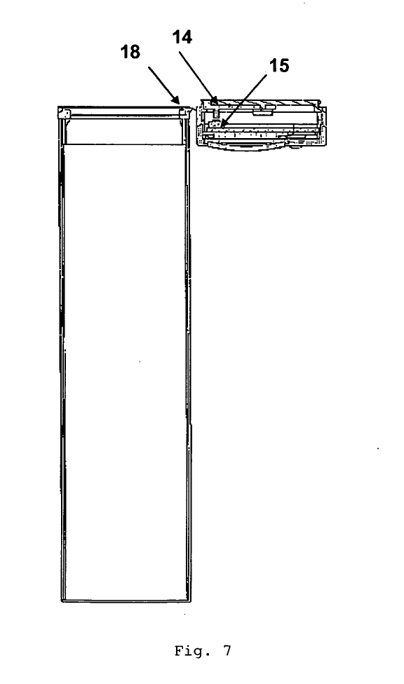

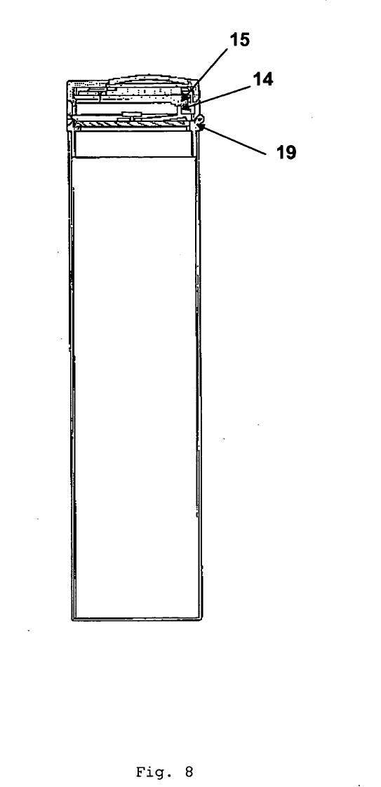

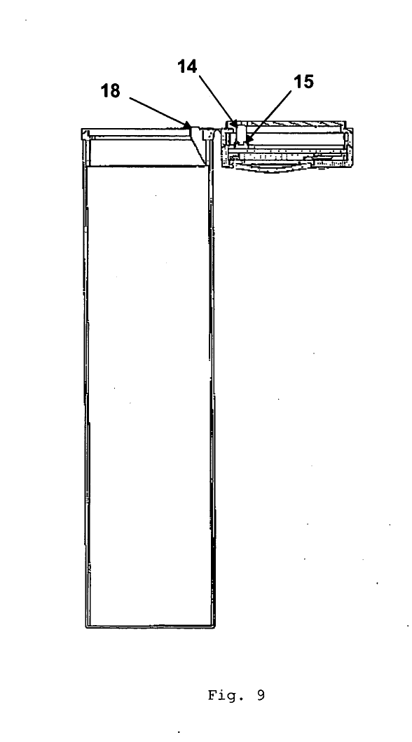

Referring to FIGS. 7 and 8, the switch activator 14 may have the shape of an arm, or may have the shape of a dome as shown in FIGS. 9 and 10. Said dome may be made of an elastomeric material.

The sensing means may further comprise a rib 18, said rib 18 being part of the inner frame 16 engaging the pill container 3. The rib 18 pushes the switch activator 14 to urge the mechanical switch 15 upward to actuate the electronic circuit 4.

The pill container 3, which may be provided to the patient or user, empty or already filled with pills, may be a bottle, a box or a card for blister packs, or simply a blister pack, and may be made of any material. In a first embodiment as shown in FIG. 1, the pill container is a conventional bottle, suitable for packing medications or other pills such as vitamins pills or nutritional supplements. Preferably, the bottle is made of glass or plastic. Preferably, the device of the present invention is a screwable cap, and more preferably a child resistant cap. Due to child security, the mechanical switch 15 may thus be a conventional spring to allow the device to move vertically by approximately 1 mm while keeping the mechanical switch in contact with the electronic circuit 4.

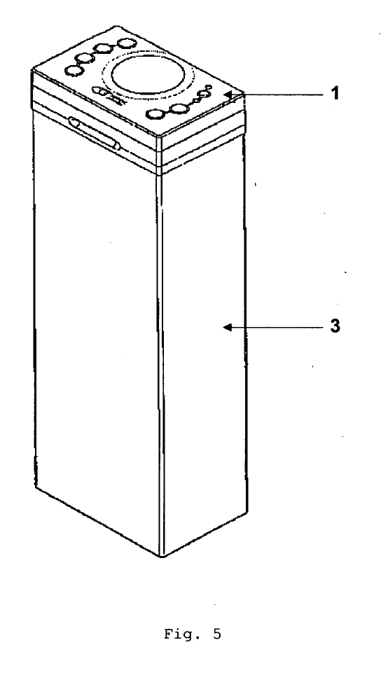

In a second embodiment as shown in FIG. 5, the pill container 3 is a box, preferably a conventional box for packing medications made in any suitable material, preferably carton or plastic. The pill container 3 may also be a card or holder for blister packs of pills made in any suitable material, preferably carton or plastic. The pill container 3 may alternatively be a conventional blister pack of pills.

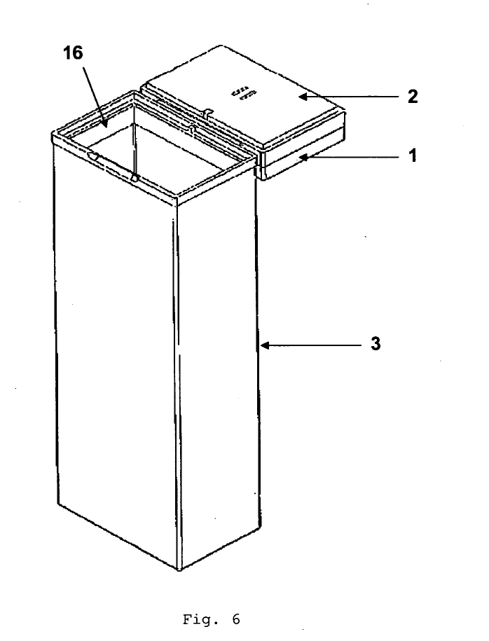

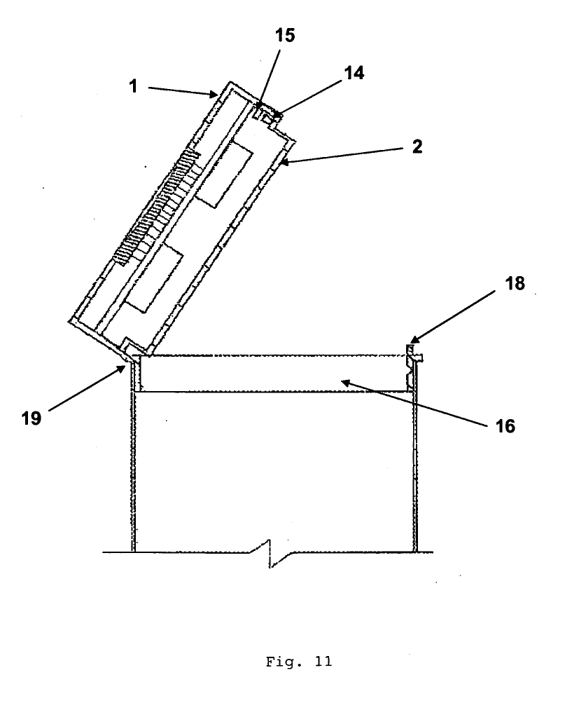

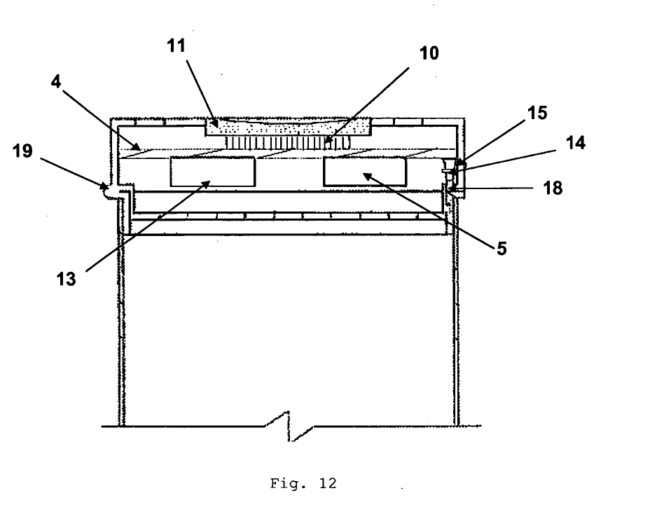

Referring to FIGS. 5 to 12, the device according the present invention may further comprise an inner frame 16 to engage with the pill container 3, preferably with the bottom case 2, the device being pivotally connected to said inner frame 16 by a hinge 19.

The device according to the present invention may be operated in any suitable manner. Preferably, based on a prescription, for medications, or the willing of the user in case of vitamins pills, a pharmacist, or the user, has to set the clock first and then to set the alarm time. The pharmacist, or the user, activates the device by removing the removable tab which is inserted between the battery and the electronic circuit 4 to save battery power. Preferably, by removal of the tab, the hours and minutes start automatically to blink on the LCD unit 10. To set the current time, the pharmacist or user presses the means 15 to adjust the correct time and has to press the means 13 to confirm the time. To set the alarm, the pharmacist or user presses the desired means 14 and presses the means 15 to adjust the required time for the alarm. The pharmacist or user has to press means 13 to confirm and the current clock time is then again displayed on the LCD unit.

Different types of alarms can be scheduled. The alarm can be set for variable intervals or preferably for specific real time.

For variable intervals, by selecting the means 14, the pharmacist or user chooses the number of alarm per day to provide. By selecting the button “1” of the means 14, the device will provide one alarm per day, by selecting the button “2” of the means 14, the device will provide two alarms per day at 12 hours apart, and so one. In case of multiple alarms, the pharmacist or user will preferably be able to set the time at which the first alarm will sound.

For specific real time alarms, referring to the particular embodiment shown in FIG. 13, the pharmacist or user can set one to four different alarms at one or four different specific times. The alarm number “1”, corresponding to the means 14 numbered “1”, may be set to “6:00” and when the device reaches 6 AM, the device will alert the user that it is time to take the medication. The pharmacist or user can set a second alarm, corresponding to the means 14 numbered “2”, at “18:00”, and then the device will alert the user twice a day, at 6 AM and at 6 PM.

Setting alarms using real time has the advantage to allow the pharmacist or user to take into account the sleeping period of the person taking the pills.

When the device activates the alarm signal, which can be an acoustic signal from the speaker or a visual signal from LCD unit 10 and/or a LED, or a combination of the three, the patient or user can press any button of the selector means 12 to “snooze”. If the pill container is not opened, the alarm will ring during a pre-determined period, preferably once every fifteen minutes for two hours. By removing the device of the present invention to access the pill container 3, the electronic circuit 4 senses that the device was removed and thus switches off the alarm and the “snooze”, and the access to the pill container 3 is electronically registered in the memory means 8. At that time the device monitors the time to activate the next alarm scheduled, if any, and monitors also the time elapsed since last registered pill container access.

If the patient or user takes the pill or medication before the scheduled alarm, preferably within a 2 hours period, the device will not issue the scheduled alarm signal, will record this access in the memory means 8 and will issue the next alarm signal.

The patient or user can check his/her compliance on last medication instance by pressing means 16. The LCD unit 10 will display in hours and minutes the time elapsed since last container access registration during five seconds for example.

The doctor or the pharmacist, or even the user, can check the patient or user compliance by pressing means 17 using the point of a pen, or any other suitable object. The LCD unit 10 will thus display the average container accesses per week, e.g. “13:7” will mean that the average number of access to the pill container is 13.7 for the current week. By pressing means 15, the LCD unit will display the access for week number 2, week number 3 and so one. A “W” will be displayed above hours, an “N” above minutes, and the week number is displayed in the “hours” section of the LCD unit 10 and the number of access is displayed in the “minutes” section, e.g. “1:14” will mean that the average number of access to the pill container 3 is “14” for the week “1”, and “2:17” will mean that the average number of access to the pill container 3 is “17” for the week “2”, and so one.

1-27. (canceled)

28. A device attachable to a pill container comprising
a case having a top case, a bottom case suitable to engage with the pill container, said case comprising at least
a clock and timer electronic circuit providing current time in hours and minutes and providing an alarm signal,
power source means,
alarm means responsive to said alarm signal,
memory means storing alarm time and recording access to the pill container,
a LCD unit to display information including current time and alarm time provided,
a LCD lens,
selector means comprising means to set a time clock, means to set an alarm, means to adjust clock time or adjust clock alarm time,
sensing means detecting an access to the pill container, comprising a switch activator which urge a mechanical switch upward when said device closes said pill container to switch off the alarm means and to register the pill container accessing into said memory means
compliance verification means comprising a microprocessor executing operational control of electronic function, giving a time elapse since last registration of an access to said pill container and executing statistical data analysis to provide average access to said pill container per day or per week.

29. The device according to claim 28, wherein the compliance verification means comprises means to check information provided by said compliance verification means.

30. The device according to claim 28, wherein the selector means and means are accessible from the top surface of the top case.

31. The device according to claim 28, wherein the selector means and means comprise pressure sensitive switches connected to the clock and timer circuit.

32. The device according to claim 28, wherein the clock and timer electronic circuit provides an alarm signal at specific real time or variable intervals.

33. The device according to claim 28, wherein the power source means is a battery.

34. The device according to claim 28, wherein the alarm means comprises a speaker and/or flashing light to illuminate the LCD unit and/or a light pipe.

35. The device according to claim 28, wherein the clock and timer electronic circuit comprises an upper surface and a lower surface, and wherein the LCD unit and selector means are mounted on said upper surface and wherein a speaker, a power source means and a sensing means are in electrical communication with said lower surface.

36. The device according to claim 28, wherein the memory means is a Random access memory (RAM).

37. The device according to claim 28, wherein the mechanical switch is a spring.

38. The device according to claim 28, wherein the switch activator is an inner sleeve which is deformed when the device closes the pill container.

39. The device according to claim 28, further comprising an inner frame to engage with the pill container, said case been pivotally connected to said inner frame by a hinge.

40. The device according to claim 28, wherein the sensing means further comprises a rib, said rib being part of an inner frame.

41. The device according to claim 28, wherein the switch activator has a shape of an arm or a dome.

42. The device according to claim 28, wherein the switch activator is an elastomeric dome.

43. The device according to claim 28, wherein the pill container is a bottle, a box, a card, or a blister.

44. The device according to claim 28, wherein the case has a cylindrical shape if the pill container is a bottle or a rectangular shape if the pill container is a box, a card or a blister.

45. The device according to claim 28, which is able to be adapted to any side of a standard pill packing box.

46. The device according to claim 28, which is a cap that may be screwably attached to the pill container when said pill container is a bottle.

47. The device according to claim 28, wherein the case is made of mouldable plastic.

48. A method to remind a person when a pill has to be taken comprising the steps of:
providing a pill container,
attaching to said pill container the device according to claim 28,
activating said device,
setting the clock time of said device,
setting at least one alarm time or at least one alarm time interval of said device and
providing an alarm signal at said alarm time or at the end of said alarm time interval.

49. The method according to claim 48, wherein the pill container is empty and wherein said pill container is filled with at least one pill.

50. The method for monitoring a person compliance with pill intake comprising the steps of:
providing a device according to claim 28,
attaching said device to a pill container,
setting the current time into said device,
sensing the pill container access,
recording and storing pill container access into memory means, and
operating compliance verification means.

51. The method according to claim 50, wherein the step of operating compliance verification means comprises a step of executing statistical data analysis and providing information on pill container access.

52. The method according to claim 50, wherein the step of operating compliance verification means comprises a step of giving the time elapsed since last registration in memory means of access to the pill container.

53. The method according to claim 50, wherein the step of operating compliance verification means comprises a step of providing average access to the pill container per day or per week.

54. A computer program that, when executed, performs the method steps of the method of claim 48, the computer program being executable on said device, the device being a programmable device.
